(19) United States
(12) Patent Application Publication
(10) Pub. No.: US 2003/0038886 A1
(43) Pub. Date: Feb. 27, 2003

(54) SIGNAL RECORDING/PLAYBACK DEVICE

(76) Inventors: KENJI FUJII, TOKYO (JP); YUKIHIRO NAKAMURA, TOKYO (JP)

Correspondence Address: FISH & RICHARDSON P.C., 45 ROCKEFELLER PLAZA, SUITE 2800, NEW YORK, NY, 10111, US

(21) Appl. No.: 08/992,779

(22) Filed: Dec. 17, 1997

(30) Foreign Application Priority Data
Dec. 25, 1996 (JP) 8-346249

(51) Int. Cl. H04N 17/00; H04N 17/02; H04N 5/76; H04N 5/445

(52) U.S. Cl. 348/231.6; 348/187; 348/231.3

(57) ABSTRACT

The object of the invention is to offer a signal recording/playback device which contributes to the efficiency of analysis work when analyzing the cause of failures of mechanical equipment or the like. A synchronization separation section 2 extracts a horizontal synchronization signal and a video signal from a television signal. A temperature sensor 4 outputs an electrical signal proportional to the measured temperature. An S/H section 5 samples the electrical signal output by the temperature sensor 4 in synchronization with the horizontal synchronization signal. The video signal data and electrical signal data corresponding to the same horizontal synchronization signal are stored at the same address in a memory section 7. On the other hand, the video signal data and electrical signal data stored at the same address in the memory section 7 are simultaneously read in synchronization with a display synchronization signal output by a display synchronization signal generating section 8. A display control section 9 displays a video image reconstructed from the video signal data and measured values indicated by the electrical signal data on the same screen in synchronization with the display synchronization signal.

### BACKGROUND OF THE INVENTION

1. Field of the Invention

The present invention relates to a signal recording/playback device for recording and playing back video signals and measurement signals which display the operations of mechanical equipment during analysis of the operation of the mechanical equipment.

This application is based on Patent Application No. Hei 8-346249 filed in Japan, the content of which is incorporated herein by reference.

2. Background Art

Conventionally, when a failure occurs in the operation of mechanical FA (factory automation) equipment during the development of FA equipment or upon delivery of completed FA equipment to clients (e.g. factories), operators usually analyze the equipment for the cause of the failure according to the following procedure.

First, an operator (1) attaches various types of measuring devices to the mechanical equipment, (2) re-activates the mechanical equipment while waiting nearby for the failure to occur, (3) records various measurement values using the attached measurement devices upon occurrence of the failure, and (4) analyzes the measurement data for the cause of the failure.

With the conventional analysis method described above, an operator watches the operations of the mechanical equipment by eye and records the measurement data upon occurrence of the failure. This process has a weakness in that the most appropriate moment for taking measurements can be missed due to the inability to predict exactly when the failure will occur.

Additionally, when the frequency of occurrence of the failure is low, there may be cases in which the failure will occur only once in several days or even several weeks.

When using the above conventional analysis method in such a case, the operator is forced to wait nearby the mechanical equipment until the failure occurs. Therefore, the work efficiency is not very good.

Additionally, even if an operator is fortunate enough to witness the failure, the account of the failure is dependent on human memory. Therefore, as time passes, the operator may forget the details of what happened when the failure occurred. The operator may also not be capable of remembering the events preceding the occurrence of the failure. Furthermore, even if one person has witnessed the failure, the person may have trouble accurately explaining the exact conditions of the failure to others.

In order to resolve these problems, it may be possible to use video cameras or the like so as to visually record the conditions of the failure, and to continuously record measurement data from the measurement devices in internal memories or HDDs (hard disk drives) provided in the measurement devices, thereby allowing the video images and measurement data to be analyzed after occurrence of the failure for the purpose of determining the cause.

However, with this method, the video recording devices and signal measurement devices are provided as respectively separate elements. Consequently, the temporal relationship between the video images and the measurement data is difficult to determine, making the analysis work inefficient.

Additionally, the recording times of video cameras are limited. Therefore, when the frequency of occurrence of the failure is low, the recording time may be insufficient to record the failure. On the other hand, in order to extend the recording time, there is a method of employing a video camera capable of recording frame-by-frame. However, this method allows the conditions of occurrence of the failure to be observed only intermittently, because the video is taken frame-by-frame.

### SUMMARY OF THE INVENTION

The present invention has the object of offering a signal recording/playback device which is useful for increasing the efficiency of analysis work when analyzing the cause of failures in mechanical equipment or the like.

The present invention offers a signal recording/playback device, comprising camera means for outputting a video signal corresponding to a filmed video image;

measuring means for measuring a predetermined object of measurement, and outputting an electrical signal corresponding to measured values; memory means for correlating and storing the video signal from the camera means and the electrical signal output from measuring means; readout means for reading out the correlated video signal and electrical signal from the memory means; and display means for simultaneously displaying a video image reconstructed from the video signal and measured values indicated by the electrical signal. Additionally, the present invention offers a signal recording/playback device, comprising camera means for outputting a television signal corresponding to a filmed video image; separating means for extracting, from the television signal, a video signal having an arbitrary scanning period and a synchronization signal indicating a synchronization position in the scanning period; measuring means for measuring a predetermined object of measurement, and outputting an electrical signal corresponding to measured values; sampling means for sampling the electrical signal from the measuring means in synchronization with the synchronization signal from the separating means; memory means for correlating and storing the video signal from the separating means and the electrical signal sampled by the sampling means; display synchronization means for generating a display synchronization signal having a predetermined period; readout means for reading out the correlated video signal and electrical signal from the memory means in synchronization with the display synchronization signal from the display synchronization means; and display means for simultaneously displaying a video image reconstructed from the video signal and measured values indicated by the electrical signal in synchronization with the display synchronization signal from the display synchronization means.

According to the present invention, video images and measurement values which are recorded simultaneously are displayed simultaneously during playback. As a result, the temporal correlation between the video images and measurement values can be easily seen, thus making analysis work using the video images and measurement values more efficient.

### BRIEF DESCRIPTION OF THE DRAWINGS

FIG. 1 is a block diagram showing an example of the structure of a signal recording/playback device according to a first embodiment of the present invention.

FIG. 2 is an explanatory diagram showing an example of a television signal output by a camera 1.

FIG. 3 is an explanatory diagram showing an example of the structure of a memory section 7.

FIG. 4 is a block diagram showing an example of the structure of a signal recording/playback device according to a second embodiment of the present invention.

FIG. 5 is an explanatory diagram showing a window trigger mode according to the same embodiment.

FIG. 6 is an explanatory diagram showing a color trigger mode according to the same embodiment.

FIG. 7 is an explanatory diagram showing a memory mode according to the same embodiment.

FIG. 8 is an explanatory diagram showing an external memory mode according to the same embodiment.

FIG. 9 is a structural diagram showing a detailed example of a signal recording/playback device according to the present invention.

FIG. 10 is an explanatory diagram showing an example of the layout of a monitor TV screen according to the same example.

### DESCRIPTION OF PREFERRED EMBODIMENTS OF THE INVENTION

1. First Embodiment

Hereinbelow, a first embodiment of the present invention shall be explained with reference to the drawings.

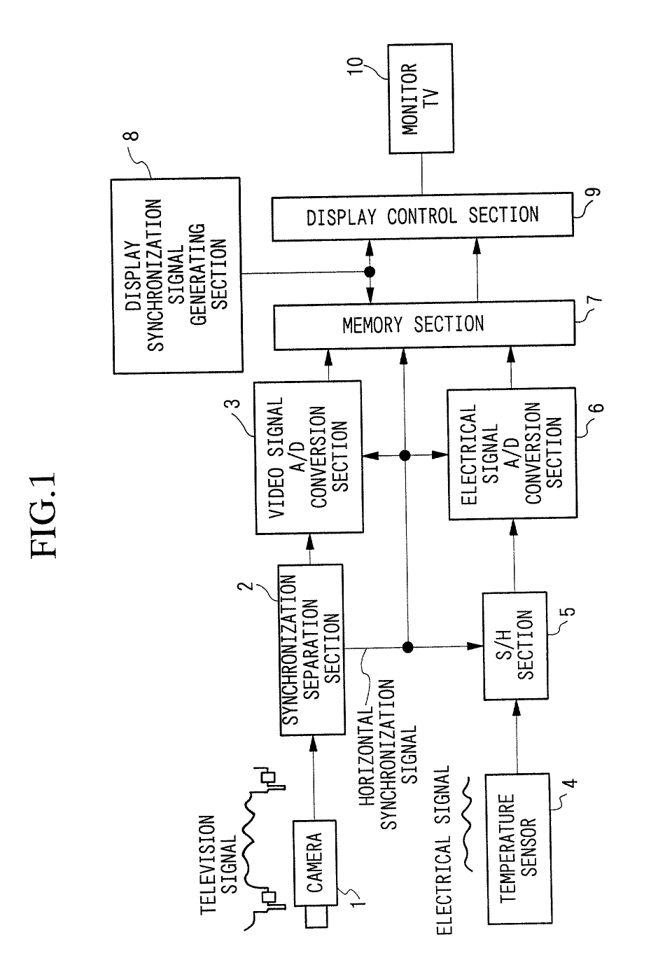

FIG. 1 is a block diagram showing an example of the structure of a signal recording/playback device according to a first embodiment of the present invention.

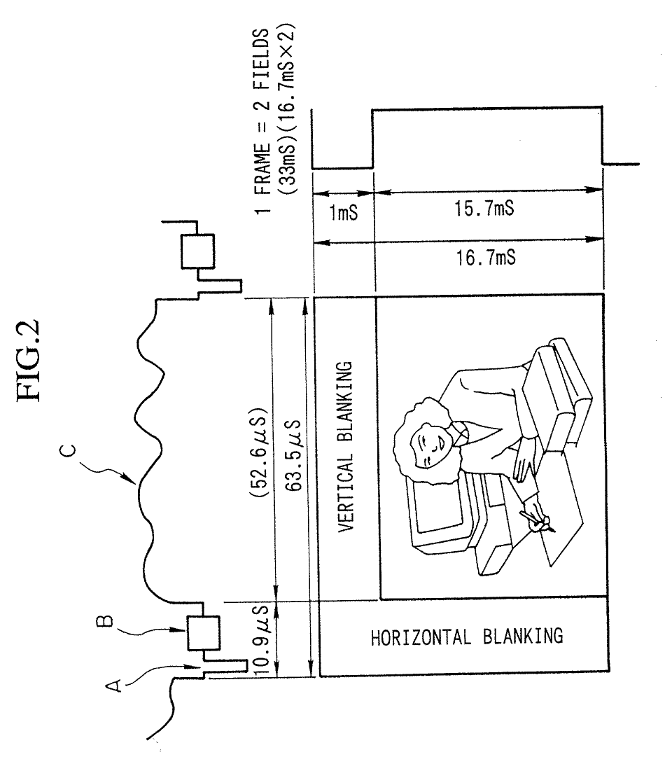

In the drawing, a camera 1, more specifically a color CCD camera, films an object and outputs television signals corresponding to the image. FIG. 2 is an explanatory diagram showing an example of a television signal output by camera 1 over a horizontal scanning period. In this drawing, A denotes a horizontal synchronization signal, B denotes a color burst signal, and C denotes a video image signal.

Additionally, in FIG. 1, a synchronization separation section 2 separates and extracts from the television signal a video signal of an arbitrary scanning period and a horizontal synchronization signal indicating the synchronization position of the scanning period. A video signal A/D conversion section 3 converts an analog video signal (analog signal) into a digital video signal (digital signal of a plurality of bits) by a preset sampling period over a single horizontal scanning period. The video signal A/D conversion section 3, more specifically composed of a commercially available video signal processing A/D converter or the like, A/D converts the input video signal in synchronization with a sampling clock.

A temperature sensor 4 is a temperature sensor using a thermocouple or the like, which outputs an electrical signal having a voltage value proportional to the measured temperature. While the temperature is measured as an example of a property being measured in the present embodiment, the present invention is applicable to cases of measurement of any type of property which is capable of being converted into electrical signals. Examples of such properties measurable by the present invention include temperature, scent, vibrations, voltage, current, wind speed, sound, atmospheric pressure, vapor pressure, amounts of rain, resistance, inductance, static electricity capacity, frequency, noise, power surges, water pressure, oil pressure, blood pressure, electrocardiograms, brain waves, electrical power outages, light, color, concentration, hydrogen ion concentration (pH), water content, chemical oxygen demand (COD), biological oxygen demand (BOD), sound pressure, physical pressure, stress, number of rotations, torsion, wear, amplitude, speed, expansion, contraction, shock, smoke, fire, opening and closing, and displacement.

Additionally, a sample-and-hold section (S/H section) 5 receives a hold signal as an input, and samples and holds the input electrical signal.

An electrical signal A/D conversion section 6, more specifically composed of a commercially available A/D converter IC, receives an enable signal as an input and A/D converts the input electrical signal.

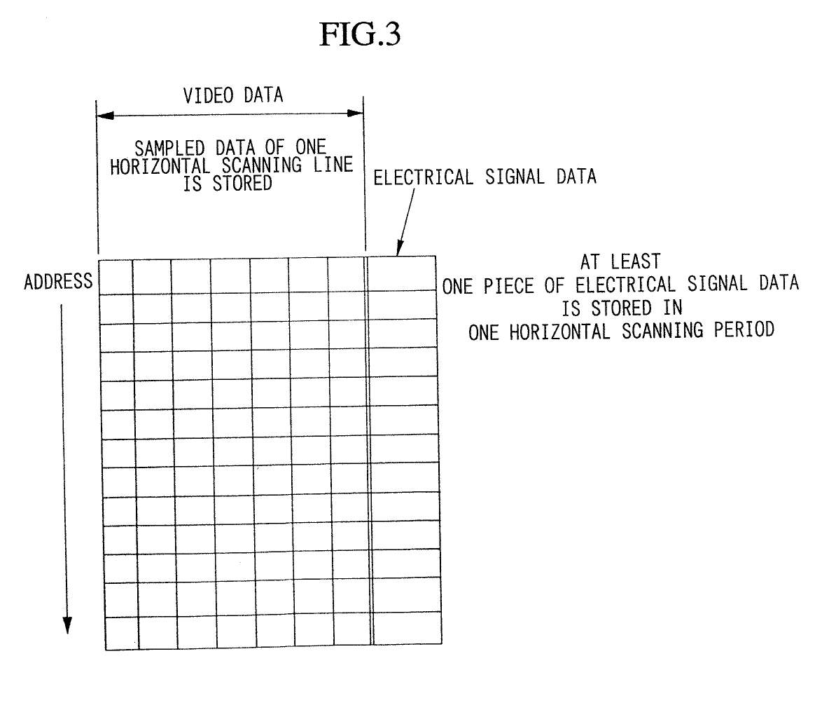

A memory section 7 is composed of an IC memory (such as a DRAM) and peripheral circuits. FIG. 3 is an explanatory diagram showing an example of the structure of a memory section 7. As shown in this drawing, the memory section 7 stores video signal data of a single horizontal scanning line of the camera 1 and corresponding electrical signal data from the temperature sensor 4 at each address. Additionally, the memory section 7 contains an internal address counter (not shown). This address counter generates write-in/read-out addresses for the memory section 7 based on a horizontal synchronization signal (input from the synchronization separation section 2) or a display synchronization signal (input from a display synchronization signal generating section 8).

The display synchronization signal generating section 8 generates and outputs a display synchronization signal having a predetermined period.

The display control section 9 receives synchronization signals and video signals as inputs and controls displays on a monitor TV 10 based on these signals.

Next, the operations of a signal recording/playback device having the above-described structure shall be explained.

(1) Recording Operation

First, a recording operation for video signals and electrical signals (corresponding to measured temperature) according to the present device will be explained.

When an operator turns on a power supply of the present device and inputs a recording start instruction, the camera 1 films an object of filming and outputs a television signal corresponding to the image. The synchronization separation section 2 extracts, from the television signal output from the camera 1, a video signal as well as a horizontal synchronization signal indicating a synchronization position of a scanning period corresponding to the video signal. The television signal A/D conversion section 3 converts an analog video signal (analog signal) extracted by the synchronization separation section 2 into video signal data (digital signal) in synchronization with a horizontal synchronization signal extracted by the synchronization separation system 2.

On the other hand, the temperature sensor 4 measures the temperature and outputs an electrical signal having a voltage value proportional to the temperature. The S/H section samples the electrical signal output by the temperature sensor 4 in synchronization with the horizontal synchronization signal extracted by the synchronization separation section 2. The electrical signal A/D conversion section 6 converts the electrical signal (analog signal) sampled by the S/H section 5 into electrical signal data (digital signal) in synchronization with horizontal synchronization signal extracted by the synchronization separation section 2.

Additionally, the address counter internal to the memory section 7 performs a count based on the horizontal synchronization signal extracted by the synchronization section 2, and generates a write-in address of the memory section 7 based on the count value. Then, the video signal data output from the video signal A/D conversion section 3 and the electrical signal data output from the electrical signal A/D conversion section 6 are synchronized with the horizontal synchronization signal extracted by the synchronization separation section 2, and stored at addresses indicated by the address counter. As a result, a video signal extracted by the synchronization separation section 2 and the electrical signal data sampled in synchronization with the synchronization signal which indicates the synchronization position of the scanning periods of that video signal are stored in the same address in the memory section 7.

Subsequently, the present device repeats the above operation with respect to television signals output by camera 1 and electrical signals output by temperature sensor 4. As a result, video signal data and electrical signal data are sequentially stored in the memory section 7. At this time, when the count value (address) of the address counter in the memory section 7 reaches the final address in the memory section 7, the address counter resets the count value to the top address in the memory section 7. Consequently, the video signal data and electrical signal data stored in the memory section 7 are renewed after each passage of a period of time determined by the final address of the memory section 7. Finally, the recording operation of the present device is terminated when an operator inputs a recording stop instruction.

(2) Playback Operation.

Next, a video signal and electrical signal playback operation of the present device shall be explained.

When the operator turns on a power supply of the present deice and inputs a playback start instruction, the display synchronization signal generating section 8 generates and outputs a display synchronization signal having a predetermined period. The address counter internal to the memory section 7 performs a count based on the display synchronization signal output by the display synchronization signal generating section 8, and generates a read-out address for the memory section 7 based on the count value. As a result, video signal data and electrical signal data stored in the same address in the memory section 7 are simultaneously read out in synchronization with the display synchronization signal output by the display synchronization signal generating section 8. The display control section 9 simultaneously displays a video image according to the video signal data output from the memory section 7 and measured values according to the electrical signal data on the monitor TV 10 in synchronization with the display synchronization signal output by the display synchronization signal generating section 8. Subsequently, the present device repeats the above operations. Finally, the display operation of the present device is terminated when an operator inputs a display stop instruction.

This completes the explanation of the operations of a signal recording/playback device according to the above-described structure.

2. Second Embodiment

Hereinbelow, a second embodiment of the present invention shall be explained with reference to the drawings.

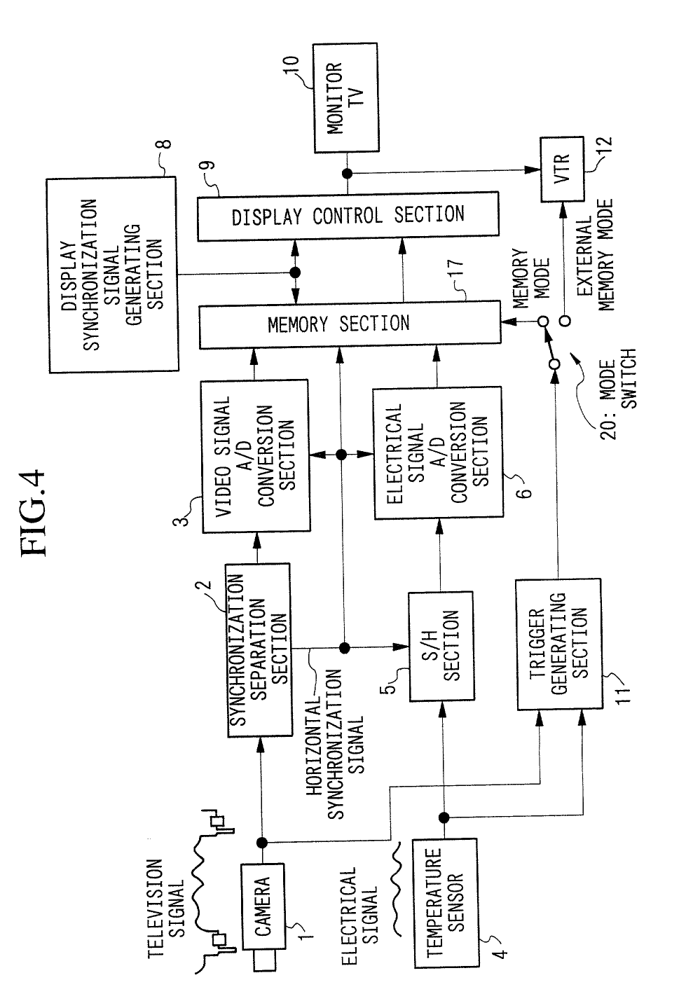

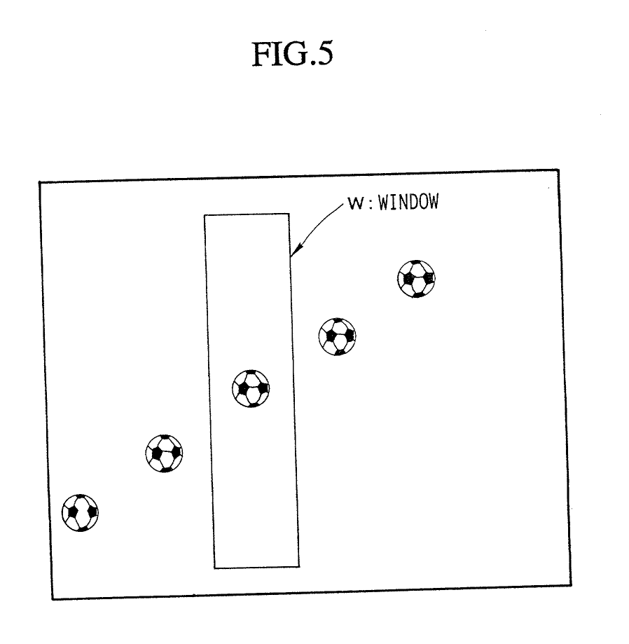

FIG. 4 is a block diagram showing an example of the structure of a signal recording/playback device according to a second embodiment of the present invention. In this drawing, the parts corresponding to those in FIG. 1 are indicated by the same reference numbers and their explanations shall be omitted.

The signal recording/playback device shown in the drawing is additionally provided with a trigger generating section 11, a mode switch 20 and a video recorder (VTR) 12.

While the mode switch 20 is represented by a mechanical contact designation in FIG. 4, the switch may also be a software switch using an IC (integrated circuit) or the like.

Additionally, the memory section 7 shown in FIG. 1 is replaced with a memory section 17 having a trigger signal input terminal in the present embodiment.

In the drawing, the trigger generating section 11 continually monitors the television signals outputted by the camera 1 or the electrical signals outputted by the temperature sensor 4, and when these signals fulfill the setting conditions given below, outputs a trigger signal. Hereinbelow, these setting conditions shall be explained.

Additionally, the operation modes of the trigger generating section 11 are largely divided into an internal trigger mode and an external trigger mode.

In this case, there are four types of internal trigger modes: (i) a time trigger mode, (ii) a window trigger mode, (iii) a color trigger mode and (iv) an image change trigger mode.

In the time trigger mode, the trigger generating section 11 monitors a timed IC (not shown) inside the trigger generating section 11, and outputs a trigger signal after the elapsation of a set period of time.

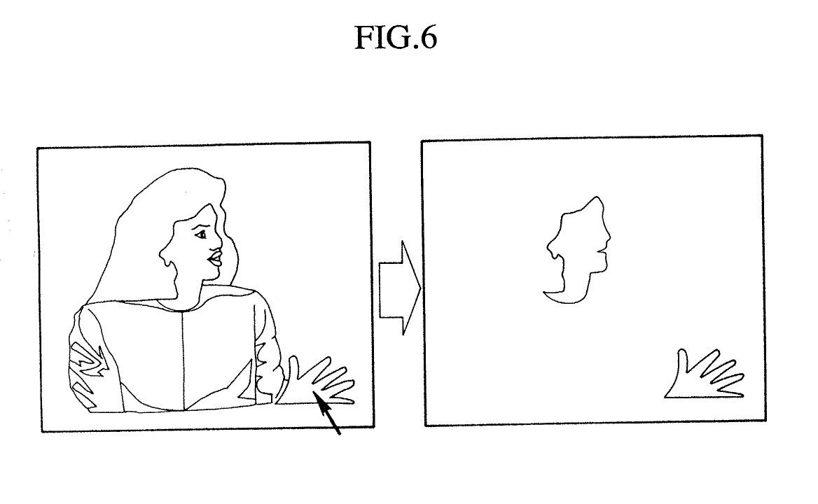

In the window trigger mode, the trigger generating section 11 outputs a trigger signal when an image inside an arbitrary window W set in the view screen of the camera 1 as shown in FIG. 6 changes. The number, position and size of the windows can be set at arbitrary values by using a window memory (not shown) inside the trigger generating section 11.

In the color trigger mode, the trigger generating section 11 outputs a trigger generating signal when a designated color (skin color in the example of FIG. 6) is detected on the view screen of the camera 1 as shown in FIG. 6. As a result, images of the occurrence of a failure can be recorded by being triggered by a warning light, a signal machine or the colors of foreign articles or the like.

In the image change trigger mode, the trigger generating section 11 outputs a trigger signal when the view screen of the camera 1 changes even slightly.

On the other hand, in the external trigger mode, the trigger generating section 11 outputs a trigger signal when the electrical signals output by the temperature sensor 4 (i.e., the detected temperatures of a temperature sensor 4) fulfill designated conditions. As with the first embodiment, any object of measurement is applicable as a trigger condition for the external trigger mode as long as the measurement is capable of being converted into an electrical signal.

While there are no particular requirements for the memory capacity of the memory section 7 in the first embodiment, since the VTR 12 is added in the present embodiment, the memory section 17 does not require such a large memory capacity. Therefore, in the present embodiment, for example, it is sufficient for the memory capacity of the memory section 17 to be such as to be capable of recording two minutes worth of video signal data and electrical signal data.

Next, the operations of the signal recording/playback device according to the above-described structure shall be explained.

(1) Recording Operation

The recording operations of the signal recording/playback device according to the present embodiment can be selected from two types of modes: (i) a memory mode and (ii) an external memory mode.

(i) Memory Mode

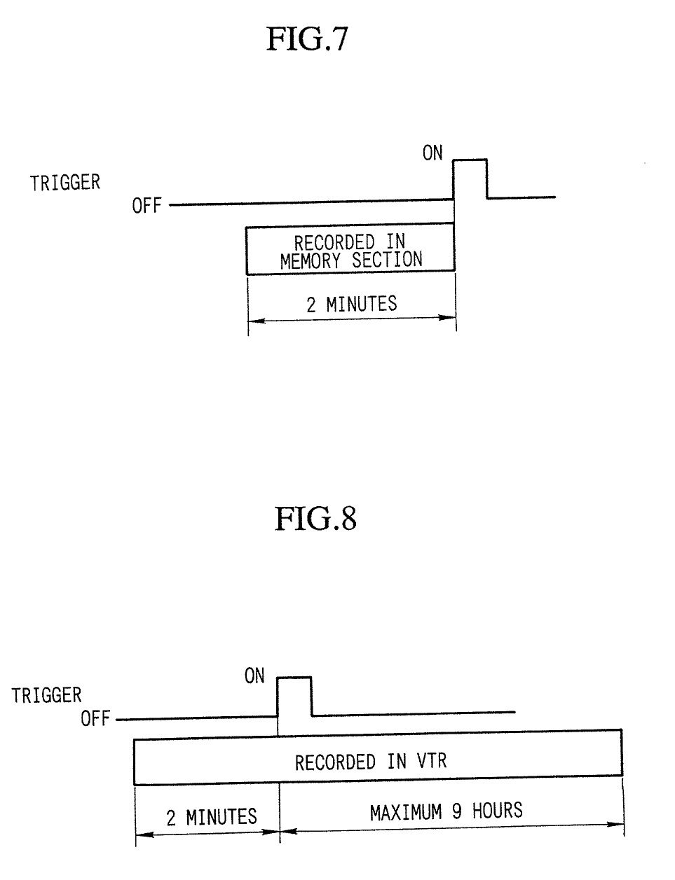

In the memory mode, the present device stores video signal data (and electrical signal data) for the two minutes prior to a trigger output in the memory section 17, as shown in FIG. 7. Hereinbelow, the recording operations of the present device in this memory mode shall be explained.

Prior to recording, the operator sets the operation mode (to memory mode) and sets the operation of the trigger memory section 11 (the type of trigger and the trigger conditions). Subsequently, when the operator inputs a recording start instruction, the present device performs operations similar to the first embodiment, and sequentially records video signal data from the camera 1 and electrical signal data from the temperature sensor 4 in the memory section 17.

On the other hand, the trigger generating section 11 continually monitors the television signals and electrical signals and outputs a trigger signal to the memory section 17 when the trigger conditions set prior to recording are fulfilled. As a result, the writing of new video signal data and electrical signal data into the memory section 17 is prohibited.

Due to the above operations, video signal data and electrical signal data of the two minutes immediately before a trigger is outputted from the trigger generating section 11 are stored in the memory section 17.

(ii) External Memory Mode

In the external memory mode, the present device stores video signal data of the two minutes prior to the trigger output and video signal data subsequent to the trigger output in the VTR 13 as shown in FIG. 8. Hereinbelow, a recording operation of the present device for the external memory mode shall be explained.

Prior to recording, the operator sets the operation mode (to external memory mode) and sets the operations of the trigger generating section 11 (the type of trigger and the trigger conditions). When mode is selected, the memory section 17 sets the address counter to an initial value, and continually outputs the data “address counter+1 address” to the display control section 9. The address counter is incremented based on a horizontal synchronization signal. As a result, the view displayed on the monitor TV 10 displays an image which is delayed by the recording time of the memory section 17 (for example, two minutes in the present embodiment).

Subsequently, when the operator inputs a recording start instruction, the present device performs an operation similar to that of the first embodiment, and sequentially records video signal data from the camera 1 and electrical signal data from the temperature sensor 4 in the memory section 17.

On the other hand, the trigger generating section 11 continually monitors the television signals and electrical signals, and instructs the VTR 12 to start recording when the trigger conditions set prior to recording are fulfilled.

Thus, the VTR 12 records images displayed on the monitor TV 10. At this time, the images displayed on the monitor TV 10 are delayed by the recording time (for example, two minutes in the present embodiment) of the memory section 17. Consequently, the images recorded in the VTR 12 are images from two minutes after the trigger generation, and the recordings indicated in FIG. 8 are possible.

(2) Playback Operation

The playback operations for the television signals recorded in the VTR 12 are the same as the playback operations for normal VTRs.

This completes the explanation of the operations of the signal recording/playback device according to the above-described structure.

3. Supplementary Description

While embodiments of the present invention have been described above with reference to the drawings, the specific structure is not restricted to these embodiments, and any modifications of design which are within a range such as not to contradict the gist of the present invention are to be understood as being included within the scope of the present invention.

4. Example

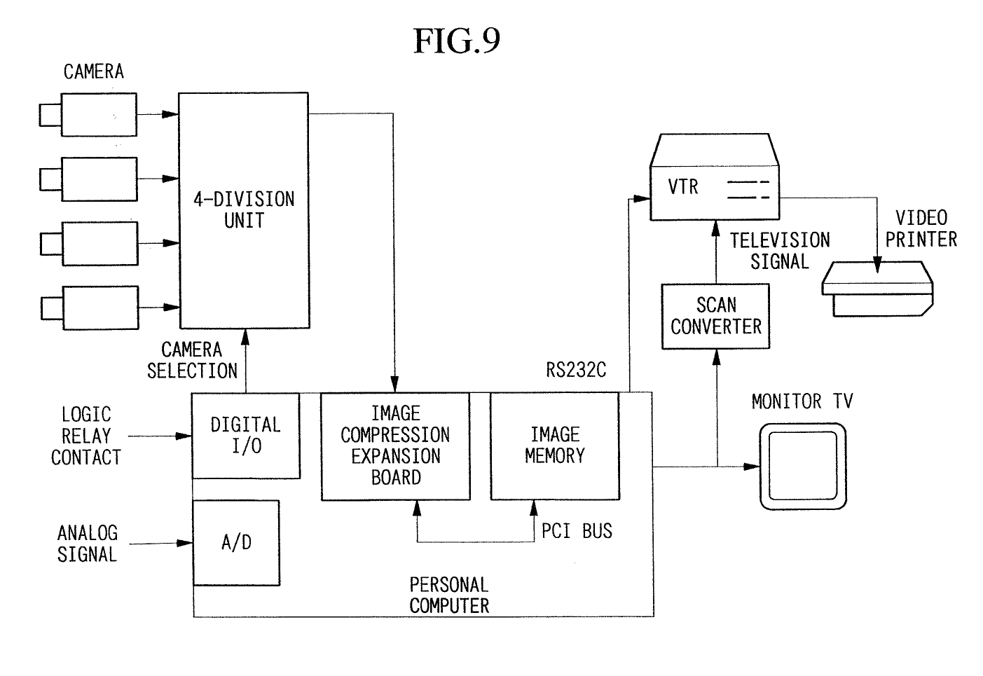

FIG. 9 is a diagram showing the structure of a specific example of a signal recording/playback device according to the present invention.

In the example shown in the drawing, four cameras are provided for filming the monitored object from different angles. Additionally, each camera is also provided with a microphone. The lenses of the cameras can be standard lenses or can be replaced with telephoto lenses or contact lenses, or replaced with light-equipped industrial endoscopes.

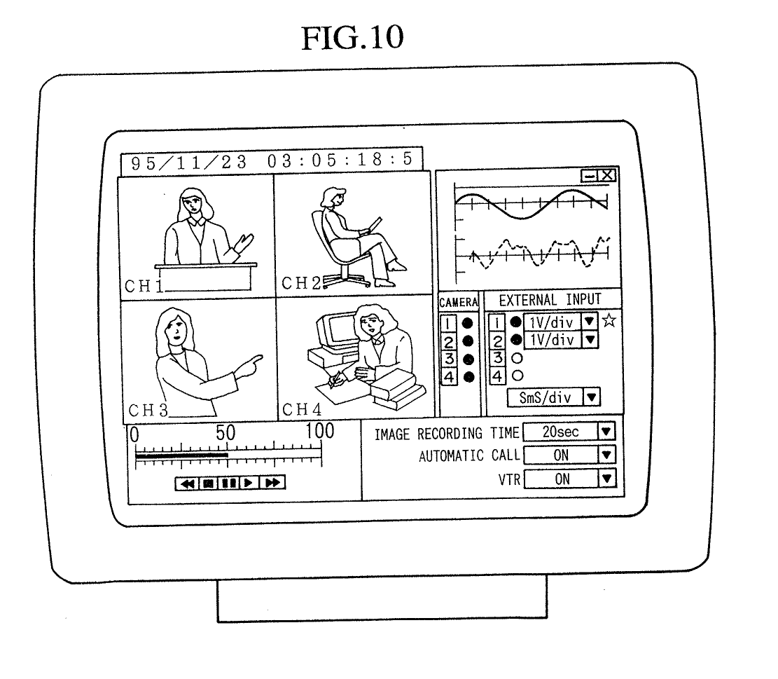

FIG. 10 is an explanatory diagram showing a n example of the layout of a monitor TV screen according to the present embodiment. As shown in the drawing, a time stamp which is renewed every 0.1 seconds is displayed on the monitor TV screen. It is possible to select one of these displays to display only the selected display, or to enlarge or shrink the displays. Additionally, these images can be played in slow-motion or in fast-forward. Additionally, the temperatures measured by the temperature sensor are input as analog signals, and displayed on a time chart synchronized with changes in the images filmed by the camera provided at the upper right of the monitor TV screen.

Additionally, while not shown in FIG. 9, it is also possible to equip the signal recording/playback device shown in the drawing with an image communication function through which a monitor center can be automatically contacted via a communication line when the trigger signal is output, so as to transfer the signals recorded by the present device (video signal data and electrical signal data) to the monitor center. Thus, it is also possible to monitor mechanical equipment for failures from a remote location.

1. A signal recording/playback device, comprising:
camera means for outputting a video signal corresponding to a filmed video image;
measuring means for measuring a predetermined object of measurement, and outputting an electrical signal corresponding to measured values;
memory means for correlating and storing the video signal from said camera means and the electrical signal output from measuring means;
readout means for reading out the correlated video signal and electrical signal from said memory means; and
display means for simultaneously displaying a video image reconstructed from the video signal and measured values indicated by the electrical signal.

2. A signal recording/playback device, comprising:
camera means for outputting a television signal corresponding to a filmed video image;
separating means for extracting, from the television signal, a video signal having an arbitrary scanning period and a synchronization signal indicating a synchronization position in the scanning period;
measuring means for measuring a predetermined object of measurement, and outputting an electrical signal corresponding to measured values;
sampling means for sampling the electrical signal from the measuring means in synchronization with the synchronization signal from the separating means;
memory means for correlating and storing the video signal from said separating means and the electrical signal sampled by said sampling means;
display synchronization means for generating a display synchronization signal having a predetermined period;
readout means for reading out the correlated video signal and electrical signal from said memory means in synchronization with the display synchronization signal from said display synchronization means; and
display means for simultaneously displaying a video image reconstructed from the video signal and measured values indicated by the electrical signal in synchronization with the display synchronization signal from said display synchronization means.

3. A signal recording/playback device in accordance with claim 2, further comprising:
trigger signal generating means for outputting a trigger signal when predetermined conditions are fulfilled during recording of the video signal and the electrical signal; and
storage means for storing a video signal and an electrical signal written into said memory means a predetermined period of time immediately prior to when the trigger signal is output.

4. A signal recording/playback device in accordance with claim 3, wherein said trigger signal generating means outputs the trigger signal after a predetermined period of time has elapsed.

5. A signal recording/playback device in accordance with claim 3, wherein said trigger signal generating means outputs the trigger signal when the video image filmed by said camera means changes.

6. A signal recording/playback device in accordance with claim 3, wherein said trigger signal generating means outputs the trigger signal when an image in a predetermined area in the video image filmed by said camera means changes.

7. A signal recording/playback device in accordance with claim 6, wherein the number, position and size of the image in the predetermined area in the video image are set to arbitrary values.

8. A signal recording/playback device in accordance with claim 3, wherein said trigger signal generating means outputs the trigger signal when a predetermined color is detected on the video image filmed by said camera means.

9. A signal recording/playback device in accordance with claim 3, wherein said trigger signal generating means outputs the trigger signal when the electrical signal output by said measuring means fulfills a predetermined condition.

10. A signal recording/playback device in accordance with claim 3, wherein said signal recording/playback device automatically connects to a monitor center via a communication line when the trigger signal is output, and transfers the recorded signals to the monitor center.

11. A signal recording/playback device in accordance with claim 2, further comprising:
trigger signal generating means for outputting a trigger signal when predetermined conditions are fulfilled during recording of the video signal and the electrical signal;
first storage means for storing a video signal and an electrical signal written into said memory means a predetermined period of tine immediately prior to when the trigger signal is output; and
second storage means for storing the video signal and electrical signal after the trigger signal is output.

12. A signal recording/playback device in accordance with claim 11, wherein said trigger signal generating means outputs the trigger signal after a predetermined period of time has elapsed.

13. A signal recording/playback device in accordance with claim 11, wherein said trigger signal generating means outputs the trigger signal when the video image filmed by said camera means changes.

14. A signal recording/playback device in accordance with claim 11, wherein said trigger signal generating means outputs the trigger signal when an image in a predetermined area in the video image filmed by said camera means changes.

15. A signal recording/playback device in accordance with claim 14, wherein the number, position and size of the image in the predetermined area in the video image are set to arbitrary values.

16. A signal recording/playback device in accordance with claim 11, wherein said trigger signal generating means outputs the trigger signal when a predetermined color is detected on the video image filmed by said camera means.

17. A signal recording/playback device in accordance with claim 11, wherein said trigger signal generating means outputs the trigger signal when the electrical signal output by said measuring means fulfills a predetermined condition.

18. A signal recording/playback device in accordance with claim 11, wherein said signal recording/playback device automatically connects to a monitor center via a communication line when the trigger signal is output, and transfers the recorded signals to the monitor center.
